(19) United States
(12) Patent Application Publication
(10) Pub. No.: US 2008/0247466 A1
(43) Pub. Date: Oct. 9, 2008

(54) Method and system for skip mode detection

(76) Inventors: Jian Wang, Sunnyvale, CA (US); Zhang Yong, Santa Clara, CA (US)

Correspondence Address: INNOVATION MANAGEMENT SCIENCES, P. O. BOX 1169, LOS ALTOS, CA, 94023-1169, US

(21) Appl. No.: 11/786,046

(22) Filed: Apr. 9, 2007

(51) Int. Cl. H04N 11/04

(52) U.S. Cl. 375/240.16; 375/E07.105

(57) ABSTRACT

A method for detecting a skip mode during encoding of a video sequence is provided. The video sequence includes a plurality of video frames, wherein each of the plurality of video frames includes a plurality of macroblocks. Each of the plurality of macroblocks includes a plurality of pixels. The method includes calculating a motion vector for a macroblock selected from the plurality of macroblocks, comparing the calculated motion vector of the macroblock with a predetermined skip motion vector of the macroblock, calculating a sum of absolute differences value for the skip motion vector of the macroblock, and selecting a skip mode for the macroblock. The skip mode is selected based on the calculated sum of absolute differences value and a predetermined threshold, wherein the predetermined threshold is based on a quantization parameter value of the macroblock.

### FIELD OF THE INVENTION

The invention relates generally to the field of video encoding. More specifically, the invention relates to a method for skip mode detection during video encoding.

### BACKGROUND OF THE INVENTION

In video encoding, various compression tools are employed for compressing images before transmission. Various international standards define these compression tools. Examples of international standards include, but are not limited to, H.263, H.264, MPEG2 and MPEG4. These standards typically use both temporal and spatial compression.

The video to be encoded includes a plurality of frames. The video frame to be encoded is divided into non-overlapping macroblocks. Each macroblock is a two dimensional array of luminance and chrominance block overlapping each other. Macroblocks may be encoded using temporal prediction and residual coding.

In temporal prediction, each of the macroblocks may be further divided into 16×16, 8×16, 16×8, 8×8, 8×4, 4×8, or 4×4 blocks of luminance data. The chrominance block size is half of the corresponding luminance block size horizontally and vertically. One or more reference pictures are designated for each frame to be encoded. During temporal prediction, a search is carried out to identify the prediction data which best matches the block of the frame to be encoded. This search process is known as motion estimation. The prediction data is identified by one or more motion vectors which provide offset information from the block of the frame to be encoded to the prediction data. Thereafter, motion compensation is performed by subtracting the block of the frame to be encoded from the prediction data. The resulting block is known as a residual block and is encoded using transform, quantization, and VLC.

During residual encoding, a block in one macroblock is subjected to discrete cosine transformation, quantization and entropy encoding of the quantized block. The encoded data is stored in the form of a bit stream and other relevant information. However, it is not necessary to encode each macroblock in a frame. If the block type of one macroblock is 16×16, with a motion vector equal to a predetermined skip motion vector and all coefficients equal to zero after quantization, then this macroblock is called a skip macroblock. Skip macroblocks are not required to be encoded, so that the coding bits are saved in the output bitstream. There are various methods to detect skip macroblock within a video frame.

One of the methods for detecting skip macroblocks is described in U.S. Pat. No. 6,993,078. The detection technique uses the luma and chroma Sum of Absolute Differences (SAD) values and the best motion vector with minimum SAD value. If luma and chroma SAD values are smaller than user-defined thresholds and the best motion vector is less than a predefined threshold, then the macroblock is considered to be a skipped one.

Another patent, U.S. Pat. No. 6,192,148, discloses a method for detecting skipped macro-block. The method uses the luma and chroma SAD values and the best motion vector with minimum SAD value. If luma and chroma SAD values are less than user-given thresholds and the motion vector is zero, then the macro block is considered to be a skipped one.

The above methods detect the macroblock after the motion estimation is done. Further, the methods described above use fixed thresholds. Using fixed thresholds may cause erroneous detection of macroblocks with useful information as skip macroblocks. This further result in loss of useful coding information.

Hence, a skip mode detection method is desired that can detect a skip macroblock during the motion estimation procedure. Further, it is desired to make the skip mode detection less dependent on a fixed threshold by incorporating adaptive features in the skip mode detection method.

### SUMMARY

In an embodiment of the present invention, the method for detecting a skip mode during motion estimation of a video sequence is provided. The video sequence includes a plurality of video frames, wherein each of the plurality of video frames includes a plurality of macroblocks. Each of the plurality of macroblocks includes a plurality of pixels. The method includes calculating a motion vector for a macroblock selected from the plurality of macroblocks, comparing the calculated motion vector of the macroblock with a predetermined skip motion vector of the macroblock, calculating a sum of absolute differences value for the motion vector of the macroblock, and selecting a skip mode for the macroblock. The skip mode is selected based on the calculated sum of absolute differences value and a predetermined threshold, wherein the predetermined threshold is based on a quantization parameter value of the macroblock.

In another embodiment of the present invention, the system includes a motion vector calculator to calculate a motion vector for a macroblock selected from the plurality of macroblocks, a motion vector comparator to compare the calculated motion vector of the macroblock with a predetermined skip motion vector of the macroblock, a sum of absolute differences calculator to calculate a sum of absolute differences value for the motion vector of the macroblock, and a skip mode selector to select a skip mode for the macroblock. The skip mode is selected based on an output from the sum of differences calculator and a predetermined threshold, wherein the predetermined threshold is based on a quantization parameter value of the macroblock.

In yet another embodiment of the present invention, the computer program product includes program instruction means for calculating a motion vector for a macroblock selected from the plurality of macroblocks, program instruction means for comparing the calculated motion vector of the macroblock with a predetermined skip motion vector of the macroblock, program instruction means for calculating a sum of absolute differences value for the motion vector of the macroblock, and program instruction means for selecting a skip mode for the macroblock. The skip mode is selected based on the calculated sum of absolute differences value and a predetermined threshold, wherein the predetermined threshold is based on a quantization parameter value of the macroblock.

### BRIEF DESCRIPTION OF THE DRAWINGS

The present invention will now be described with reference to the accompanied drawings that are provided to illustrate various example embodiments of the invention. Throughout the description, similar reference names may be used to identify similar elements.

FIG. 1 depicts an exemplary video frame of video data in accordance with various embodiments of the invention;

FIG. 2 depicts a flowchart, illustrating a method of skip mode detection for a macroblock of a video frame, in accordance with various embodiments of the invention;

FIGS. 3a and 3b depict a flowchart, illustrating a method of skip mode detection for a macroblock of a video frame, in accordance with one embodiment of the invention;

FIGS. 4a and 4b depict a flowchart, illustrating a method of skip mode detection for a macroblock of a video frame, in accordance with another embodiment of the invention;

FIG. 5 illustrates an environment in which various embodiments of the invention may be practiced;

FIG. 6a is a block diagram of an encoder system with skip mode detection, in accordance with an embodiment of the invention;

FIG. 6b is a block diagram of an encoder system with skip mode detection, in accordance with another embodiment of the invention;

FIG. 7 is a block diagram of a skip mode detection module, in accordance with an embodiment of the invention;

FIG. 8 is a block diagram of an encoder system with skip mode detection, in accordance with yet another embodiment of the invention;

FIG. 9 is a table illustrating a set of exemplary predetermined threshold values for quantization parameter values; and

FIG. 10 is a graph illustrating variation of quantization parameter values with respect to the set of exemplary predetermined threshold values.

### DESCRIPTION OF VARIOUS EMBODIMENTS

Various embodiments of the invention provide a method, system and computer program product for skip mode detection during encoding of a video frame. A filtered video frame, divided into macroblocks, is input into an encoder system. Motion estimation is performed on a macroblock during which one or more motion vectors of the macroblock is calculated. Thereafter, a sum of absolute differences (SAD) value for the motion vector is calculated if the motion vector is a skip motion vector. A skip mode is selected based on the comparison of sum of absolute differences value with a predetermined threshold.

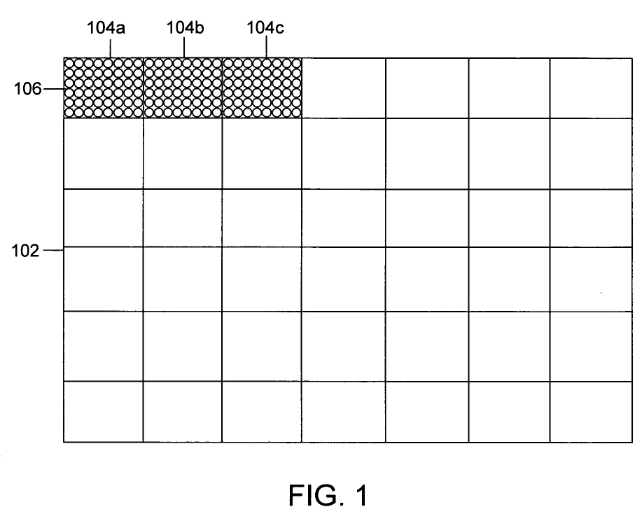

FIG. 1 depicts an exemplary video frame 102 in accordance with an embodiment of the invention. Video frame 102 is divided into a plurality of macroblocks, such as macroblocks 104, including for example macroblocks 104a, 104b and 104c. A macroblock is defined as a region of a video frame coded as a unit, usually composed of 16×16 pixels. However, different block sizes and shapes are possible under various video coding protocols. Each of the plurality of macroblocks 104 includes a plurality of pixels. For example, macroblock 104a includes pixels 106. Each of the macroblocks 104 and pixels 106 includes information such as color values, chrominance and luminance values and the like.

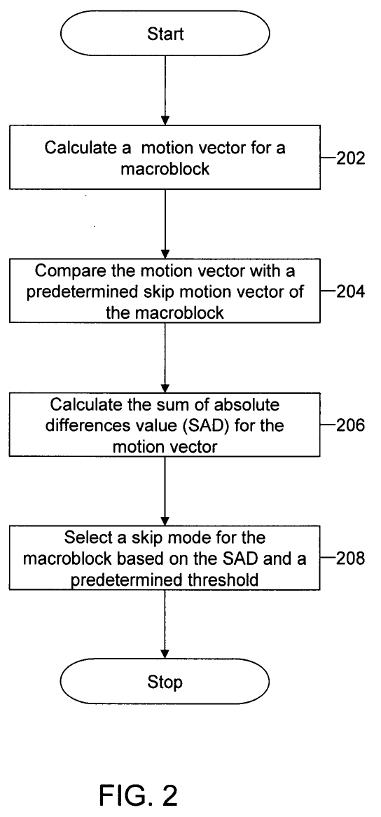

FIG. 2 depicts a flowchart, illustrating a method of skip mode detection for a macroblock, such as macroblock 104a, of a video frame, in accordance with various embodiments of the invention. At step 202, a motion vector for the macroblock is calculated. The motion vector of a macroblock is given as:

\vec{mv}=(mvx,mvy) (1)

where the mvx and mvy are the horizontal and vertical distance between the current macroblock and reference macroblock.

At step 204, the calculated motion vector is compared with a predetermined skip motion vector of the macroblock. The predetermined skip motion vector for the macroblock is calculated as median of motion vectors of three neighboring macroblocks. For example, the predetermined skip motion vector for a macroblock whose three neighboring macroblocks are a, b and c, is calculated as:

\vec{ps}=median(\vec{mva},\vec{mvb},\vec{mvc}) (2)

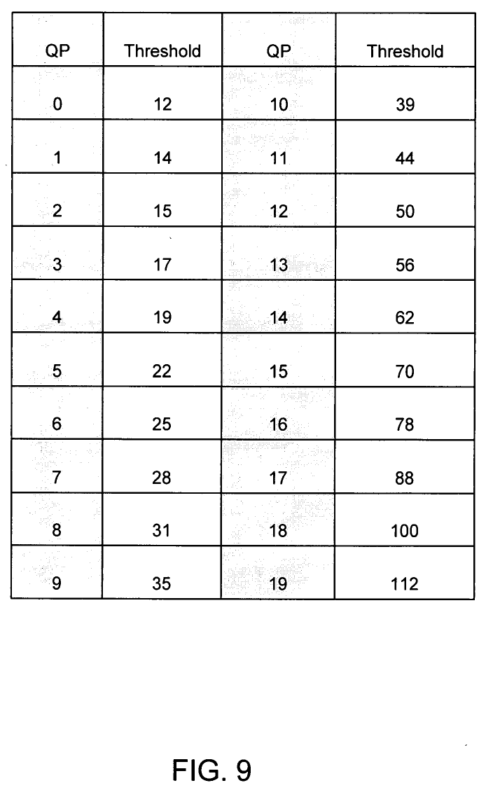

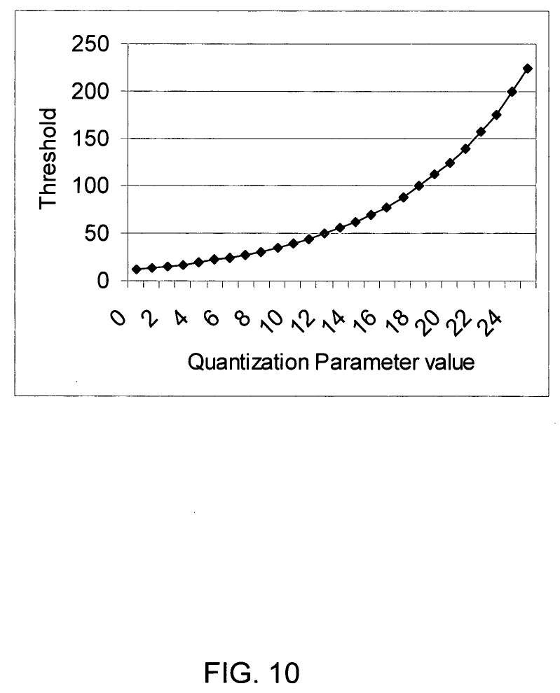

Subsequently, at step 206, a Sum of Absolute Differences (SAD) value is calculated for the motion vector. The SAD is calculated as:

$$SAD ( c , r ) = {\sum }_{m = 0}^{BW - 1} {\sum }_{n = 0}^{BH - 1} \vert c ( m , n ) - r ( m - mvx , n - mvy ) \vert \qquad ( 3 )$$

where c and r indicate the macroblock and its best matching block respectively, BW and BH are macroblock width and macroblock height respectively. Thereafter, at step 208, a skip mode is selected for the macroblock based on its sum of absolute differences value and a predetermined threshold. The predetermined threshold is based on quantization parameter value of the macroblock. Different quantization parameters of macroblocks, such as macroblocks 104, will have unique predetermined thresholds. The variation of the predetermined threshold with the quantization parameter value is described in conjunction with FIG. 9 and FIG. 10.

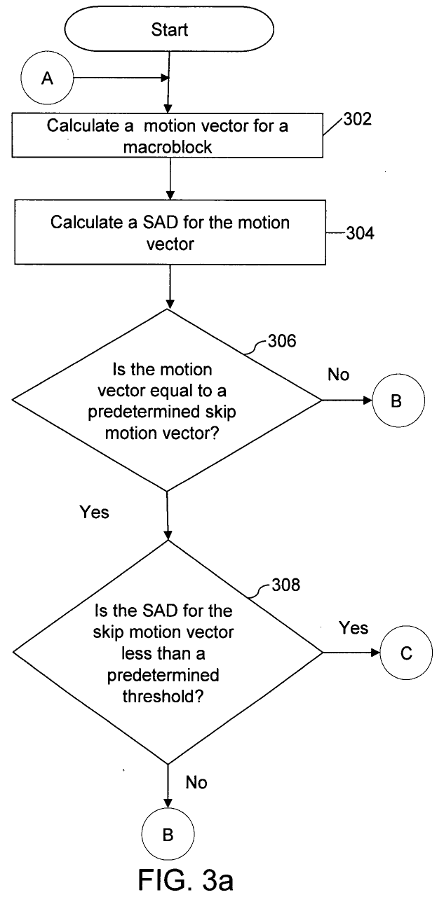

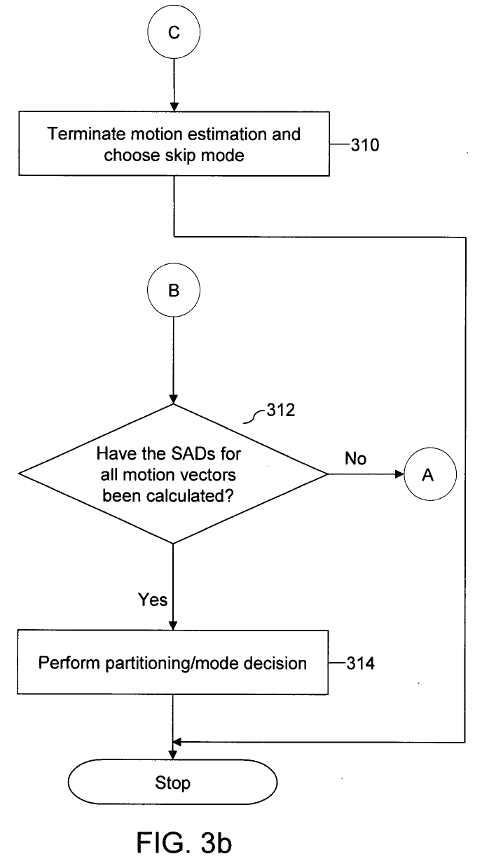

FIGS. 3a and 3b depict a flowchart, illustrating a method of skip mode detection for a macroblock, such as macroblock 104a, of a video frame, such as video frame 102, in accordance with an embodiment of the invention. At step 302, a motion vector for the macroblock is calculated in accordance with equation (1). At step 304, the SAD value for the corresponding motion vector is calculated with equation (3). At step 306, the calculated motion vector is compared with a predetermined skip motion vector of the macroblock. If the motion vector is equal to the predetermined skip motion vector then, at step 306, a SAD value is calculated for the motion vector of the macroblock using equation (3). If the motion vector is not equal to the predetermined skip motion vector then, at step 312, SAD values are computed and compared to decide the best motion vector and block type for the macroblock, such as macroblocks 104 in the video frame.

At step 308, the SAD value for the skip motion vector of the macroblock is compared with a predetermined threshold. If the SAD value is less than the predetermined threshold then, at step 310, motion estimation process for the macroblock is terminated and a skip mode is selected for the macroblock. If the SAD value for the skip motion vector is not less than the predetermined threshold then, at step 312, SADs for all motion vectors will be calculated for the macroblock. If SADs for all motion vectors have been calculated for the macroblock then, at step 314, partitioning and mode decision is performed using a partitioning and mode decision algorithm. A detailed description of one such partitioning and mode decision algorithm is provided in a commonly owned co-pending U.S. Provisional Patent Application Ser. No. (TBD), bearing attorney docket WWCI-025-888, entitled ‘Method for Reference Picture Selection and Mode Decision in Inter Picture Coding’, filed herewith and the entirety of which is incorporated herein by reference. If SADs for all the motion vectors have not been calculated for the macroblock, then the steps 304 to 312 are repeated for other macroblocks, such as macroblock 104b, 104c and so forth.

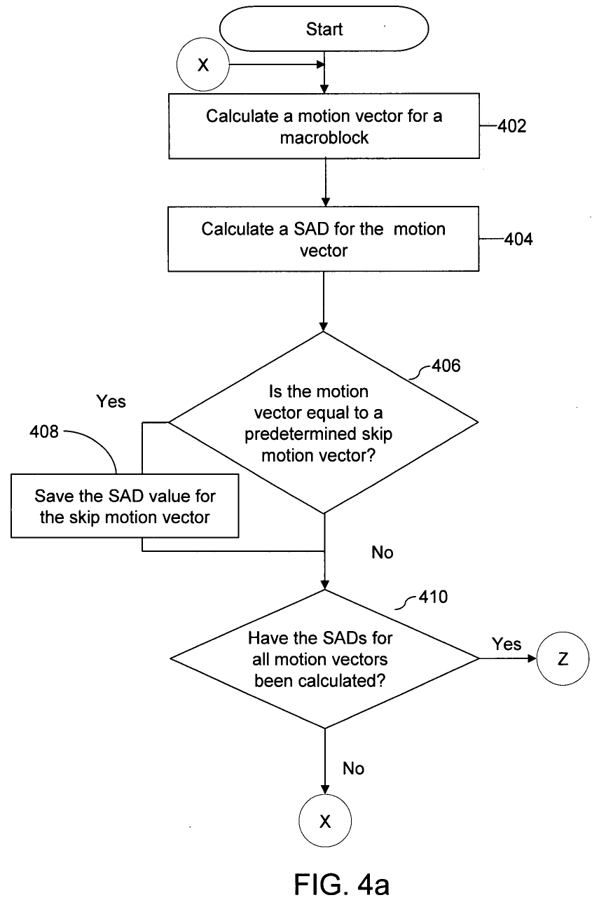

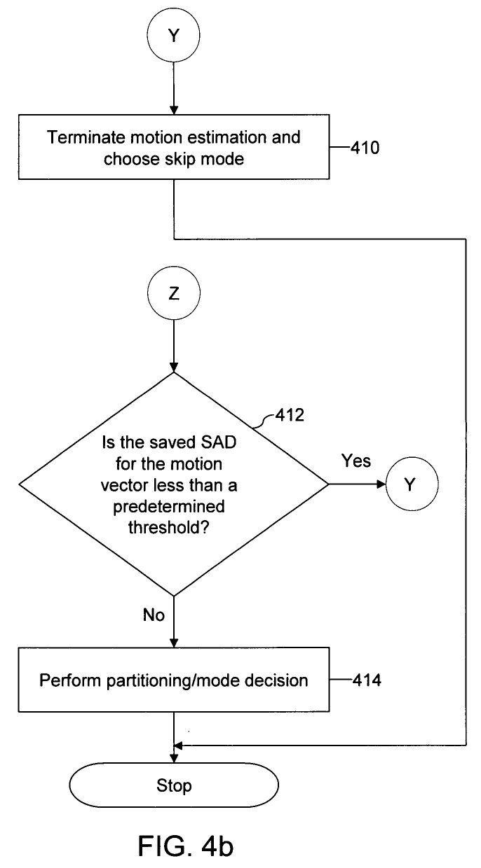

FIGS. 4a and 4b depict a flowchart, illustrating a method of skip mode detection for a macroblock, such as macroblock 104a, of a video frame, such as video frame 102, in accordance with another embodiment of the invention. At step 402, a motion vector for the macroblock is calculated in accordance with equation (1). At step 404, the SAD value for the corresponding motion vector is calculated with equation (3). After that, at step 406, the calculated motion vector is compared with a predetermined skip motion vector of the macroblock. The predetermined skip motion vector is calculated in accordance with equation (2). If the motion vector is equal to the predetermined skip motion vector then, at step 408, the SAD value for the skip motion vector is saved. If the motion vector is not equal to the predetermined skip motion vector then, at step 410, it is determined if SADs for all the motion vectors have been calculated for the macroblock. If SADs for all motion vectors have not been calculated for the macroblock, then steps 404 to 410 are repeated for the macroblock.

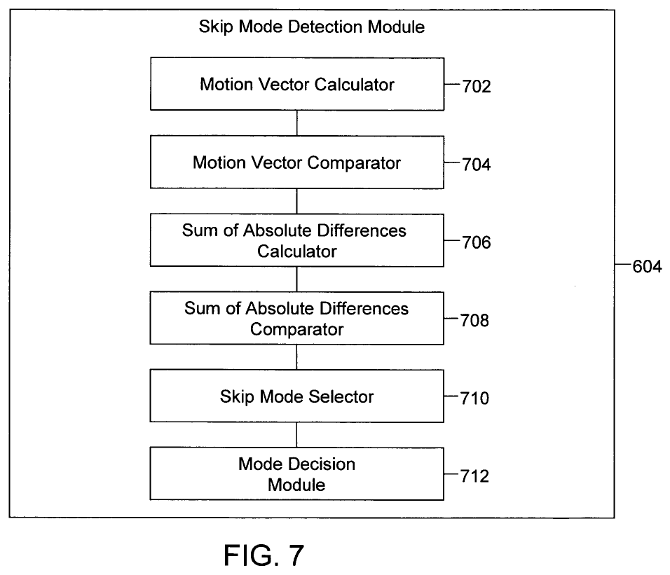

After calculating SADs for all the motion vectors then, at step 412, it is determined if the SAD value for the skip motion vector of the macroblock is less than a predetermined threshold. If the SAD value for the skip motion vector of the macroblock is less than the predetermined threshold then, at step 410, the motion estimation process is terminated and the macroblock is designated as a skip macroblock. If the SAD value for the skip motion vector of the macroblock is not less than the predetermined threshold then, at step 414, partitioning and mode decision is performed using normal mode decision algorithms. The above method is implemented using hardware modules. In an embodiment of the present invention, the steps 412 and 414 may be added as a separate module. The details of the hardware modules are described in conjunction with FIG. 7.

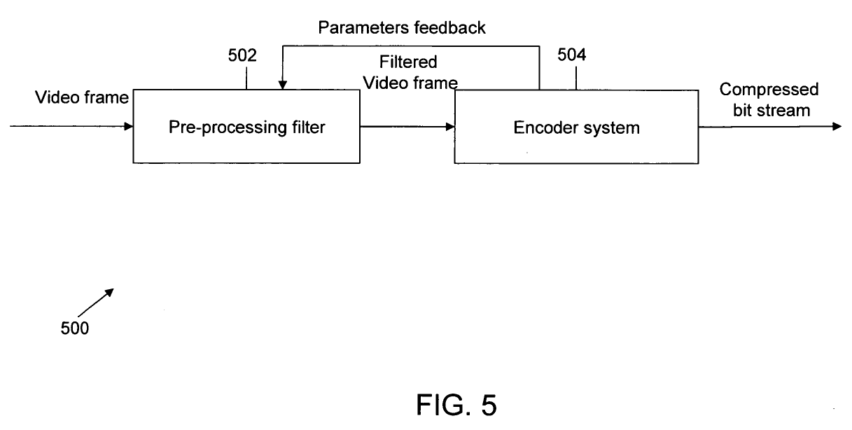

FIG. 5 illustrates an environment 500 in which various embodiments of the invention may be practiced. Environment 500 includes a pre-processing filter 502 and an encoder system 504. A video frame 102 is input into pre-processing filter 502. Pre-processing filter 502 filters video frame 102.

Video frame 102 is input into an encoder system 504 to obtain a compressed bit stream an encoder system 504 may be embodied as a standard encoder known in the art that are compatible with codecs such as H.263, H.264, MPEG4 and the like.

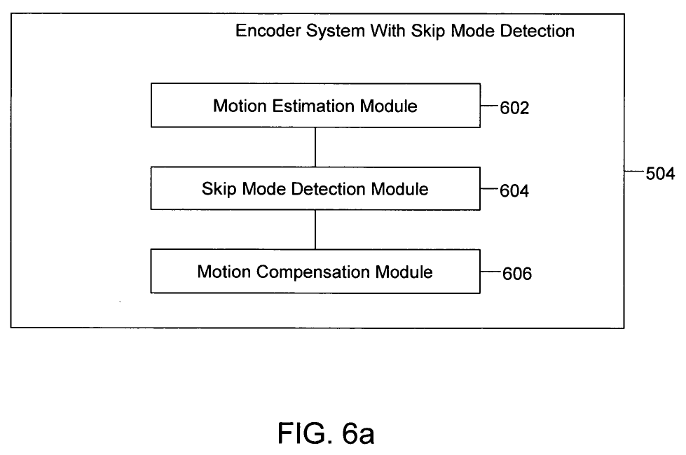

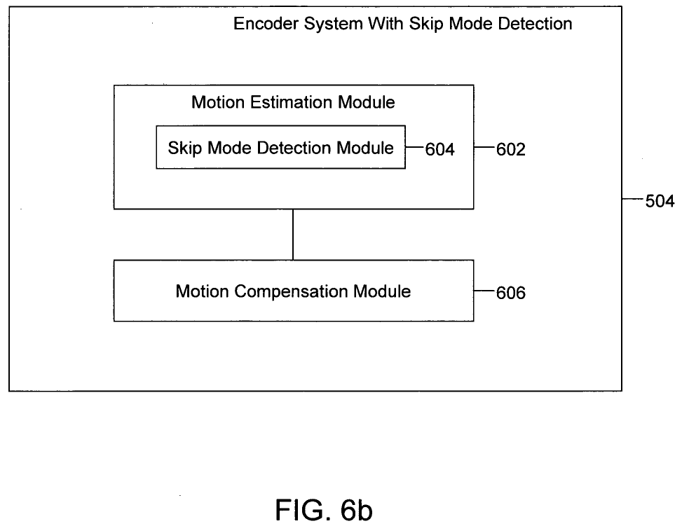

FIG. 6a is a block diagram of an encoder system with skip mode detection 504, in accordance with an embodiment of the invention. The encoder system 504 includes a motion estimation module 602, a skip mode detection module 604, and a motion compensation module 606.

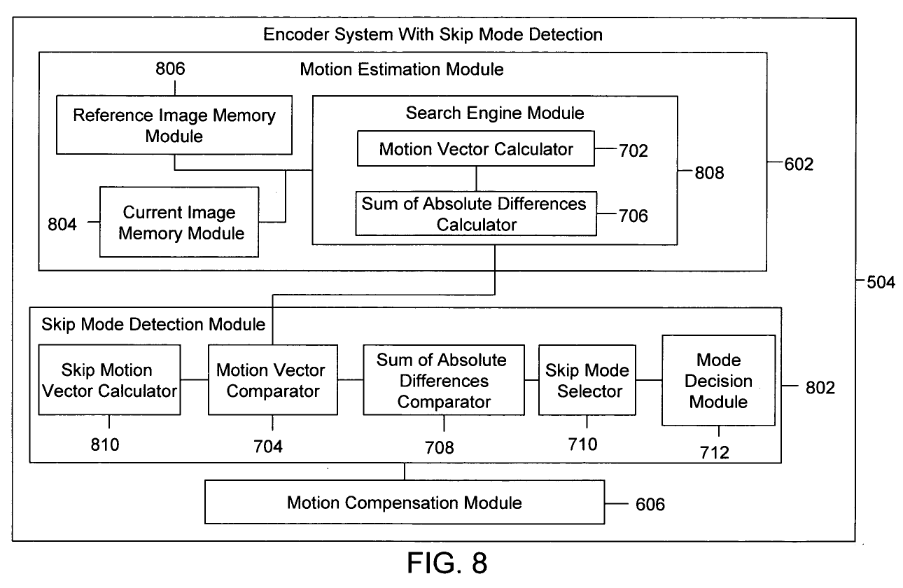

In this embodiment of the invention, skip mode detection module 604 works independently of motion estimation module 602. Motion estimation module 602 performs motion estimation to determine best matching reference macroblock and a motion vector for macroblock 104a. In this embodiment of the invention, motion estimation module 602 works in accordance with the method described in conjunction with FIG. 4. Motion estimation module 602 communicates the SAD value for the motion vector of macroblock 104a to skip mode detection module 604. Skip mode detection module 604 determines if macroblock 104a is a skip macroblock and then selects a skip mode for macroblock 104a. The skip macroblock is determined using the SAD value of the motion vector of macroblock 104a in accordance with equation (3). Skip mode detection module 604 communicates the skip mode decision to motion compensation module 606. If skip mode is not selected by skip mode detection module 604 then motion compensation module 606 performs motion compensation on macroblock 104a. Motion compensation includes determining a residual macroblock by subtracting the best matching reference data from macroblock 104a. The hardware implementation of this embodiment of the invention is described in detail in conjunction with FIG. 8.

FIG. 6b is a block diagram of an encoder system 504, in accordance with another embodiment of the invention an encoder system 504 includes motion estimation module 602 and motion compensation module 606. Motion estimation module 602 includes skip mode detection module 604.

Motion estimation module 602 performs motion estimation to determine a best matching reference macroblock for macroblock 104a. During motion estimation, skip mode detection module 604 determines if macroblock 104a is a skip macroblock and thus selects a skip mode for macroblock 104a. The skip macroblock is determined using the SAD value of the motion vector of macroblock 104a in accordance with equation (3). Motion estimation module 602 communicates the best matching reference macroblock information and the skip mode information to motion compensation module 606. Motion compensation module 606 performs motion compensation on macroblock 104a. Motion compensation includes determining a residual macroblock by subtracting the best matching reference macroblock from macroblock 104a. In this embodiment, motion estimation module 602 works in accordance with the method described in conjunction with FIG. 3. Further, the hardware implementation of this embodiment of the invention is described in detail in conjunction with FIG. 7.

FIG. 7 is a block diagram of skip mode detection module 604, in accordance with an embodiment of the invention. Skip mode detection module 604 includes a motion vector calculator 702, a motion vector comparator 704, a sum of absolute differences calculator 706, a sum of absolute differences comparator 708, a skip mode selector 710 and a mode decision module 712. Skip mode detection module 604 works in accordance with the method described in conjunction with FIG. 3 and FIG. 4.

Motion vector calculator 702 calculates a motion vector of macroblock 104a, in accordance with equation (1). Subsequently, motion vector comparator module 704 compares the calculated motion vector with a predetermined skip motion vector of macroblock 104a. The predetermined skip motion vector is calculated in accordance with equation (2). If the motion vector is equal to the predetermined skip motion vector, then sum of absolute differences calculator 706 calculates a SAD value for the motion vector of macroblock 104a. Thereafter, sum of absolute differences comparator 708 compares the SAD value for the motion vector of macroblock 104a with a predetermined threshold. If the SAD value is less than the predetermined threshold, skip mode selector 710 selects the skip mode for macroblock 104a. Skip mode selector 710 determines if macroblock 104a should choose the skip mode. Mode decision module 712 determines the best mode. In this embodiment of the invention, skip mode detection module 604 may be implemented as a hardware module within motion estimation module 602.

FIG. 8 is a block diagram of an encoder system with skip mode detection 504, in accordance with another embodiment of the invention. The encoder system 504 includes motion estimation module 602, a skip mode detection module 802 and motion estimation module 606. Motion estimation module 602 includes a current image memory module 804, a reference image memory module 806, and a search engine module 808. Search engine module 808 further includes motion vector calculator 702 and sum of absolute differences calculator 706. Skip mode detection module 802 includes a skip motion vector calculator 810, motion vector comparator 704, sum of absolute differences comparator 708, skip mode selector 710, and mode decision module 712.

In this embodiment of the invention, skip mode detection module 802 works independently of motion estimation module 602. Current image memory module 804 and reference image memory module 806 communicate respective current image information and reference image information for a macroblock 104a, to search engine module 808. Search engine module 808 includes motion vector calculator 702 and sum of absolute differences calculator 706. Motion vector calculator 702 calculates a motion vector for macroblock 104a in accordance with equation (1). Sum of absolute differences calculator 706 calculates a SAD value of the motion vector for macroblock 104a based on the output of current image memory module 804 and reference image memory module 806. The SAD value is calculated in accordance with equation (3). Search engine module 808 communicates the SAD value and the motion vector to motion vector comparator 704.

Motion vector comparator 704 compares the motion vector for macroblock 104a with a predetermined skip motion vector. The predetermined skip motion vector is calculated by skip motion vector calculator 810 in accordance with equation (2). If the motion vector is equal to the predetermined skip motion vector, motion vector comparator 704 records the SAD value for the motion vector. Motion vector comparator 704 communicates the SAD value to sum of absolute differences comparator 708. Sum of absolute differences comparator 708 compares the SAD value with a predetermined threshold. If the SAD value is less than the predetermined threshold then skip mode selector 710 selects the motion vector as a skip motion vector and skip mode is selected for macroblock 104a. If the skip-mode is not selected for macroblock 104a, then block type decision module 712 determines the best mode for macroblock 104a. Skip mode detection module 604 communicates the skip mode decision to motion compensation module 606. However, if the skip mode is not selected for macroblock 104a, then motion compensation module 606 performs motion compensation on macroblock 104a.

FIG. 9 is a table illustrating a set of exemplary predetermined threshold values for quantization parameter values. Different quantization parameters of macroblocks, such as macroblocks 104, will have unique predetermined thresholds. For example, in an embodiment of the present invention, macroblock 104a, 104b and 104c may have different predetermined thresholds according to their calculated quantization parameter values. The predetermined threshold values for various quantization parameter values are determined empirically considering various video sequences.

FIG. 10 is a graph illustrating variation of quantization parameter values with respect to the set of exemplary predetermined threshold values. The graph has been plotted using the table illustrated in FIG. 9.

The invention provides a method, system and computer program product for skip mode detection. The method and system combines the steps of detecting a skip mode during and after the motion estimation process. For software-based solution, the system enables an early termination of the motion estimation process when the skip mode has been detected. For hardware-based solution, the system enables bit reduction by choosing skip mode during the motion estimation process.

Further, the invention uses comparison of SAD values with predetermined threshold values. In various embodiments of the present invention, a unique predetermined threshold value is used for each macroblock depending on the quantization parameter of the macroblock.

The computer program product of the invention is executable on a computer system for causing the computer system to perform a method of filtering an image including an image filtering method of the present invention. The computer system includes a microprocessor, an input device, a display unit and an interface to the Internet. The microprocessor is connected to a communication bus. The computer also includes a memory. The memory may include Random Access Memory (RAM) and Read Only Memory (ROM). The computer system further comprises a storage device. The storage device can be a hard disk drive or a removable storage drive such as a floppy disk drive, optical disk drive, etc. The storage device can also be other similar means for loading computer programs or other instructions into the computer system. The computer system also includes a communication unit. The communication unit allows the computer to connect to other databases and the Internet through an I/O interface. The communication unit allows the transfer as well as reception of data from other databases. The communication unit may include a modem, an Ethernet card, or any similar device that enables the computer system to connect to databases and networks such as LAN, MAN, WAN and the Internet. The computer system facilitates inputs from a user through input device, accessible to the system through I/O interface. The various modules may also be in the form of hardware units.

The computer system executes a set of instructions that are stored in one or more storage elements, in order to process input data. The set of instructions may be a program instruction means. The storage elements may also hold data or other information as desired. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. Further, the software may be in the form of a collection of separate programs, a program module with a larger program or a portion of a program module, as in the present invention. The software may also include modular programming in the form of object-oriented programming. The processing of input data by the processing machine may be in response to user commands, results of previous processing or a request made by another processing machine.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

Furthermore, throughout this specification (including the claims if present), unless the context requires otherwise, the word “comprise”, or variations such as “comprises” or “comprising”, will be understood to imply the inclusion of a stated element or group of elements but not the exclusion of any other element or group of elements. The word “include,” or variations such as “includes” or “including,” will be understood to imply the inclusion of a stated element or group of elements but not the exclusion of any other element or group of elements. Claims that do not contain the terms “means for” and “step for” are not intended to be construed under 35 U.S.C. § 112, paragraph 6.

What is claimed is:

1. A method for detecting a skip mode during encoding of a video sequence, the video sequence comprising a plurality of video frames, each of the plurality of video frames comprising a plurality of macroblocks, each of the plurality of macroblocks comprising a plurality of pixels, the method comprising:
a) calculating a motion vector for a macroblock selected from the plurality of macroblocks;
b) comparing the calculated motion vector of the macroblock with a predetermined skip motion vector of the macroblock;
c) calculating a sum of absolute differences value for the motion vector of the macroblock; and
d) selecting a skip mode for the macroblock, the skip mode being selected based on the calculated sum of absolute differences value and a predetermined threshold, wherein the predetermined threshold is based on a quantization parameter value of the macroblock.

2. The method according to claim 1, wherein the sum of absolute differences value for the motion vector is determined if the motion vector is equal to the predetermined skip motion vector.

3. The method according to claim 2 further comprising calculating the motion vector of each of the plurality of macroblocks if the motion vector is not equal to the predetermined skip motion vector.

4. The method according to claim 1, wherein the motion vector is calculated for each of the plurality of macroblocks if the sum of absolute differences value is at least as large as the predetermined threshold.

5. The method according to claim 1, wherein the skip mode is selected if the calculated sum of absolute differences value for the motion vector of the macroblock is less than the predetermined threshold.

6. The method according to claim 5 further comprising terminating the motion estimation for the macroblock.

7. A system for detecting a skip mode during encoding of a video sequence, the video sequence comprising a plurality of video frames, each of the plurality of video frames comprising a plurality of macroblocks, each of the plurality of macroblocks comprising a plurality of pixels, the system comprising:
a) a motion vector calculator to calculate a motion vector for a macroblock selected from the plurality of macroblocks;
b) a motion vector comparator to compare the calculated motion vector of the macroblock with a predetermined skip motion vector of the macroblock;
c) a sum of absolute differences calculator to calculate a sum of absolute differences value for the motion vector of the macroblock; and
d) a skip mode selector to select a skip mode for the macroblock, the skip mode being selected based on an output from the sum of differences calculator and a predetermined threshold, wherein the predetermined threshold is based on a quantization parameter value of the macroblock.

8. The system according to claim 7, wherein the sum of absolute differences value calculator calculates the sum of absolute differences value based on an output of the motion vector comparator.

9. The system according to claim 8 further comprising the sum of absolute differences calculator calculating the sum of absolute differences value if the motion vector is equal to the predetermined skip motion vector.

10. The system according to claim 8 further comprising the motion vector calculator calculating the motion vector of each of the plurality of macroblocks if the motion vector is not the predetermined skip motion vector.

11. The system according to claim 7 further comprising a sum of absolute differences comparator to compare the sum of absolute differences value with the predetermined threshold.

12. The system according to claim 11 further comprising the skip mode selector selecting the skip mode if the calculated sum of absolute differences value is less than the predetermined threshold.

13. The system according to claim 12 further comprising a motion estimation terminating module to terminate the motion estimation of the macroblock if the skip mode selector selects the skip mode.

14. The system according to claim 12 further comprising the motion vector calculator calculating the motion vector of each of the plurality of macroblocks if the skip mode selector does not select the skip mode.

15. A computer program product detecting a skip mode during encoding of a video sequence, the video sequence comprising a plurality of video frames, each of the plurality of video frames comprising a plurality of macroblocks, each of the plurality of macroblocks comprising a plurality of pixels, the computer program product comprising:
a) program instruction means for calculating a motion vector for a macroblock selected from the plurality of macroblocks;
b) program instruction means for comparing the calculated motion vector of the macroblock with a predetermined skip motion vector of the macroblock;
c) program instruction means for calculating a sum of absolute differences value for the motion vector of the macroblock; and
d) program instruction means for selecting a skip mode for the macroblock, the skip mode being selected based on the calculated sum of absolute differences value and a predetermined threshold, wherein the predetermined threshold is based on a quantization parameter value of the macroblock.

16. The computer program product according to claim 15, wherein program instruction means determines the sum of absolute differences value for the motion vector if the motion vector is equal to the predetermined skip motion vector.

17. The computer program product according to claim 16 further comprising program instruction means for calculating the motion vector of each of the plurality of macroblocks if the motion vector is not equal to the predetermined skip motion vector.

18. The computer program product according to claim 15, wherein program instruction means calculates the motion vector for each of the plurality of macroblocks if the sum of absolute differences value is more than the predetermined threshold.

19. The computer program product according to claim 15, wherein program instruction means selects the skip mode if the calculated sum of absolute differences value for the motion vector of the macroblock is less than the predetermined threshold.

20. The computer program product according to claim 19 further comprising program instruction means for terminating the motion estimation for the macroblock.
